(19) United States
(12) Patent Application Publication
(10) Pub. No.: US 2026/0060471 A1
(43) Pub. Date: Mar. 5, 2026

(54) MULTI-BOTTLE THERMAL MODULATION ASSEMBLY

(71) Applicant: Yizhack Benatar, Hollywood, FL (US)

(72) Inventor: Yizhack Benatar, Hollywood, FL (US)

(21) Appl. No.: 18/818,043

(22) Filed: Aug. 28, 2024

(51) Int. Cl. A47J 36/24; A23C 3/05

(52) U.S. Cl. CPC A47J 36/2433; A23B 11/145

(57) ABSTRACT

A multi-bottle thermal modulation assembly that has a housing defining a chamber and a plurality of housing channels each spanning into the chamber for receiving a bottle, a plurality of heating coils each surrounding one of the plurality of housing channels in a helical configuration and operably configured to have a warming mode configured to generate an ambient temperature in a range of 100-350° F., a mechanical refrigeration unit operably configured to have a cooling mode configured to generate a temperature within the chamber in a range of 32-40° F., and a controller communicatively coupled each of the plurality of heating coils and the mechanical refrigeration unit and operably configured to selectively cause the warming mode of one of the plurality of heating coils while the mechanical refrigeration unit is in the cooling mode.

### FIELD OF THE INVENTION

The present invention relates generally to thermally modulated bottle holders and, more particularly, relates to assemblies configured to hold, cool, and warm baby bottles.

### BACKGROUND OF THE INVENTION

There are many people desire to cool or warm bottles, namely baby bottles. Parents and other individuals routinely need to store breast milk and other liquid in a cooled environment until it is needed. Many users store the milk and other liquid in a bottle for quick and effective delivery. When needed, parents and other individuals routinely desire to warm up the liquid in the bottle, as many children prefer warm milk to cool milk.

For example, the U.S. Centers for Disease Control and Prevention (CDC) states that leftover breast milk can still be used within two hours after the baby is finished feeding. After two hours, leftover breast milk should be thrown away. To avoid wasting unfed milk, the CDC recommends storing, thawing, and warming it in smaller amounts. Specifically, fresh or pumped milk can be stored at room temperature (77° F. or colder) for up to four hours, in a refrigerated environment for up to four days, and if frozen, for approximately 6-12 months.

Breast milk that is too cold when delivered can cause digestive issues and discomfort to a child, wherein breast milk that is too hot (i.e., above 104° F.) can destroy nutrients and burn a child's mouth, throat, and esophagus. As such, the recommend and desired temperature for breast milk and other liquids delivered to children is within the range of 95-104° F.

Many known assemblies only warm or cool a baby bottle, which is impractical for many individuals as they are required to then use separate assemblies or methodologies to deliver milk or other liquids, thereby delaying the delivery time. Other known devices are limited to warming or cooling a single bottle, which is also impractical for many users desiring to have a set feeding schedule with shortened intervals between feedings for a child. Other known devices are inefficiently configured for use by an individual and/or are cumbersome and impractical for many individuals.

Therefore, a need exists to overcome the problems with the prior art as discussed above.

### SUMMARY OF THE INVENTION

The invention provides a multi-bottle thermal modulation assembly that overcomes the hereinafore-mentioned disadvantages of the heretofore-known devices and methods of this general type and that can cool a plurality of bottles, thereby preserving the contents of the same, and, when desired by the user, enable selective warming of one of the bottles while the other remaining bottles in the assembly are still being cooled.

With the foregoing and other objects in view, there is provided, in accordance with the invention, a multi-bottle thermal modulation assembly having a housing defining a chamber, defining a plurality of housing openings, and a plurality of housing channels each spanning into the chamber from one of the plurality of housing openings, and shaped and sized to receive a baby bottle, a plurality of heating coils each surrounding one of the plurality of housing channels in a helical configuration and operably configured to have a warming mode configured to generate an ambient temperature in a range of 100-350° F., a mechanical refrigeration unit operably configured to have a cooling mode configured to generate a temperature within the chamber in a range of 32-40° F., and a controller communicatively coupled each of the plurality of heating coils and the mechanical refrigeration unit and operably configured to selectively cause the warming mode of one of the plurality of heating coils while the mechanical refrigeration unit is in the cooling mode.

In accordance with a further feature of the present invention, each of the plurality of housing channels spanning into the chamber and is of a channel diameter ranging from 1-5inches and each of the plurality of housing channels uniformly spans a channel diameter into the chamber, wherein the channel diameter ranges from 1-5inches.

In accordance with another feature, an embodiment of the present invention includes the housing having an upper wall having an upper wall surface defining the plurality of housing openings, a bottom wall with a planar surface coupled thereto and configured to support the housing, and a sidewall surrounding the upper wall and the bottom wall.

In accordance with yet another feature, an embodiment of the present invention also includes the housing having a plurality of internal bottle retaining sidewalls spanning into the chamber and each defining one of the plurality of housing channels and having one of the plurality of heating coils directly coupled thereto in the helical configuration.

In accordance with an additional feature of the present invention, each of the plurality of internal bottle retaining sidewalls and the plurality of housing channels are of a cylindrical shape configured to retain a baby bottle.

In accordance with a further feature, an embodiment of the present invention also includes a plurality of bottom retaining walls each coupled to one of the plurality of internal bottle retaining sidewalls to form a bottle support structure and a plurality of lower heating coils each directly coupled to one of the plurality of bottom retaining walls, communicatively coupled to the controller, and operably configured to have a warming mode configured to generate an ambient temperature in a range of 100-150° F., wherein the controller is operably configured to selectively cause the warming modes of both the one of the plurality of heating coils and one of the lower heating coils in the same bottle support structure.

In accordance with an exemplary feature, an embodiment of the present invention also includes each bottle support structure having an outer support surface with one of the heating coils and one of the plurality of lower heating coils directly coupled thereto and an inner support surface opposing the outer support surface and defining one of the plurality of housing channels.

In accordance with an additional feature, an embodiment of the present invention also includes a plurality of removable bottle holders each selectively removably coupled to one of the bottle support structures and disposed in the respective housing channel, each having a bottle holder sidewall, and each having a bottle holder bottom wall.

In accordance with yet another feature, an embodiment of the present invention also includes each of the plurality of removable bottle holders having a flange projecting laterally from the bottle holder sidewall and configured to rest on top of the upper wall surface of the upper wall of the housing.

In accordance with an additional feature, an embodiment of the present invention also includes a thermocouple disposed proximal to the bottle holder sidewall of one of the plurality of removable bottle holders and communicatively coupled to the controller, wherein the controller is operably configured to selectively terminate the warming mode of the one of the plurality of heating coils after a heating time period when the thermocouple senses a determined heating temperature.

In accordance with another feature, an embodiment of the present invention also includes an electronic display screen communicatively coupled to the controller and operably configured to receive tactile input that includes the heating time period, the determined heating temperature, and the temperature within the chamber.

In accordance with a further feature, an embodiment of the present invention also includes a speaker communicatively coupled to the controller, wherein the controller is operably configured to cause the speaker to emit a sound when the heating time period expires.

In accordance with a further feature, an embodiment of the present invention also includes a plurality of removable bottle holders each selectively removably coupled to the housing, disposed in one of the plurality of housing channels, and each having a bottle holder sidewall and a bottle holder bottom wall.

In accordance with yet another feature, an embodiment of the present invention also includes a thermocouple disposed proximal to the bottle holder sidewall of one of the plurality of removable bottle holders and communicatively coupled to the controller, wherein the controller is operably configured to selectively terminate the warming mode of the one of the plurality of heating coils after a heating time period when the thermocouple senses a determined heating temperature.

Although the invention is illustrated and described herein as embodied in a multi-bottle thermal modulation assembly, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not necessarily drawn to scale but, where applicable, may be utilized to support a particular structural configuration or geometric relationship between components utilized in the assembly.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the housing or, where applicable, in the direction from the lower wall of the housing to the upper wall of the housing. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of a multi-bottle thermal modulation assembly in accordance with one embodiment of the present invention;

FIG. 2 is an exploded view of the assembly in FIG. 1;

FIG. 3 is a cross-sectional view of the assembly in FIG. 1 along section line 3-3;

FIG. 4 is a side elevational view of the assembly in FIG. 1;

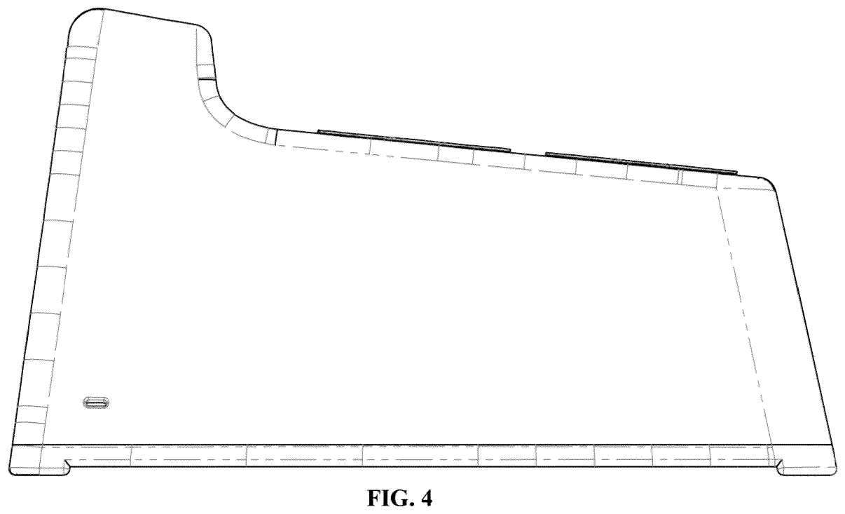

FIG. 5 is a top plan view of the assembly in FIG. 1; and

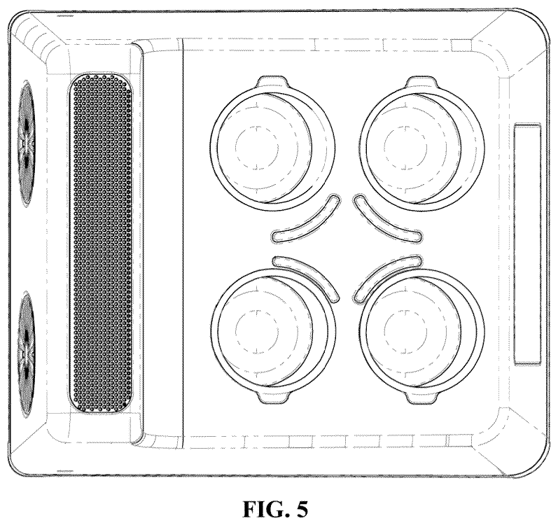

FIG. 6 is a block diagram depicting electrical components utilized in the assembly of FIG. 1 in accordance with one embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

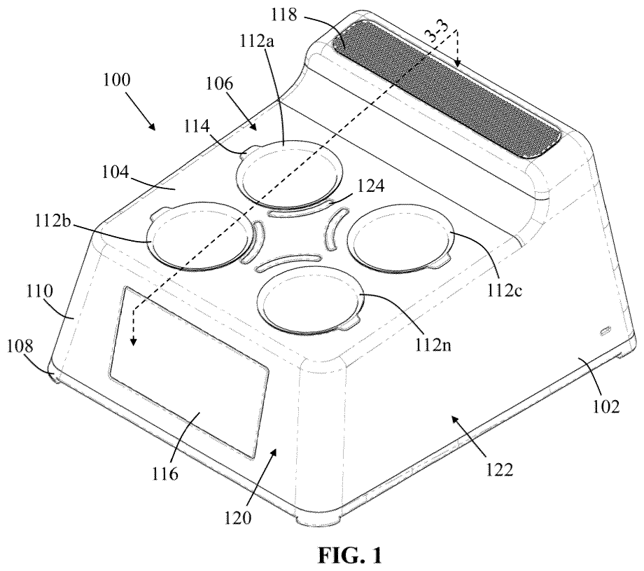

The present invention provides a novel and efficient multi-bottle thermal modulation assembly that can effectively, efficiently, and safely cool multiple bottles and, while said bottles are being cooled, selectively warm a bottle desired to be delivered to a user in an effective manner. Referring principally now to FIGS. 1-3, one embodiment of the present invention is shown. The figures show several advantageous features of the present invention, but, as will be described below, the invention can be provided in several shapes, sizes, combinations of features and components, and varying numbers and functions of the components. The first example of a multi-bottle thermal modulation assembly 100 includes a housing 102 that defines a chamber 300 and a plurality of housing openings 200a-n thereon, wherein “n” represents any number greater than one. The housing 102 effectively holds and cools multiple bottles (e.g., bottle 304) when desired. The housing 102 is preferably made with a substantially rigid material, e.g., polystyrene, acrylonitrile butadiene styrene (ABS), aluminum, etc., and may also be preferably of an insulative material or include an insulative liner coupled to an inside surface of the housing 102. The housing 102 may also define a plurality of housing channels 202a-n each spanning into the chamber 300 from one of the plurality of housing openings 200a-n. Each of the housing channels 202a-n are shaped and sized to receive a baby bottle, e.g., the bottle 304. Said another way, the housing channels 202a-n, which may be defined by integral wall of the housing 102, a heating coil 204, or another structure such as a removable bottle holder 112. As used herein, the term “wall” is intended broadly to encompass continuous structures, as well as, separate structures that are coupled together so as to form a substantially continuous external surface. In one embodiment, the housing 102 is portable and handheld, i.e., it may be less than approximately 10lbs and/or may be capable of be handheld by a user without any auxiliary equipment.

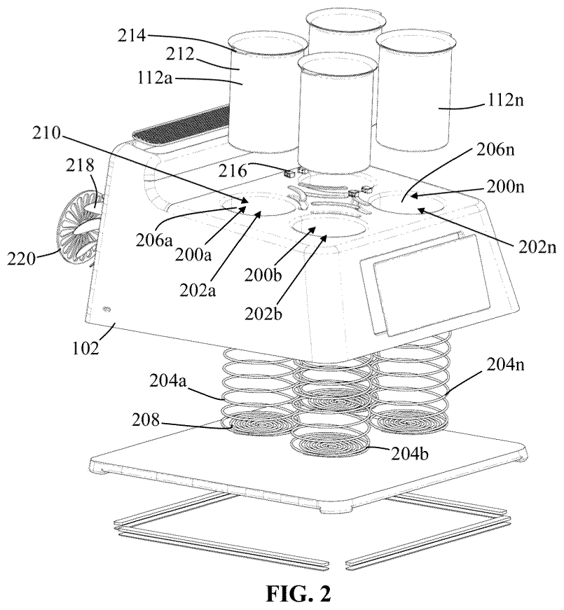

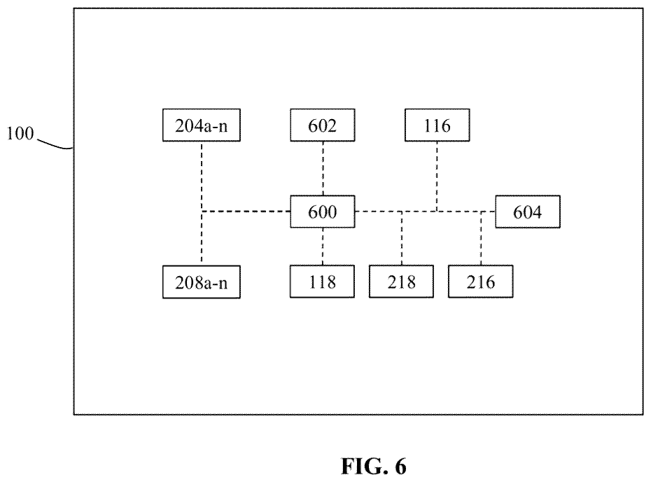

In one embodiment, the plurality of heating coils 204a-n each respectively surround one of the plurality of housing channels 202a-n in a helical configuration and are operably configured to have a warming mode configured to generate an ambient temperature in a range of 100-150° F. As best seen in FIG. 2, the heating coils 204a-n may be a slender metallic wire that is preferably substantially rigid and are each electrically couplable to a power source 604 (depicted in FIG. 6). The power source is preferably an external 120V A/C outlet, wherein the assembly may also include a rectifier to convert A/C to D/C within the assembly. The power source 604 may also be an internal battery. The heating coils 204a-n may also be a metallic tape configured in a helical, or spiral, configuration. Further, each of the heating coils 204a-n, 208 may consist of a polyimide heating film with a 100K thermistor, enabling the entire surface to heat up to 300-350° F., which enables efficient heat transfer sufficient to heat the liquid in the bottle within a range of range of 98-102° F.

While the heating coils 204a-n generate an ambient temperature within a range of 100-350° F., the assembly is configured to warm an individual bottle within a range of 98-102° F., the preferred distribution temperature so the contents of the bottle is not overheated and the contents are destroyed. The heating coils 204 are disposed in at least a vertical orientation, or in a direction spanning from a bottom wall 108 of the housing 102 to an upper wall 104 of the housing 102. The precise generated temperature of the heating coils 204 sufficient to heat the bottle contents to the desired temperature will principally depend on the surface area in which the bottle is exposed directly or indirectly to the coils 204a-n and the material, or lack thereof, separating the heating coils 204a-n and the bottle 304.

The housing 102 preferably is made up of an upper wall 104 having an upper wall surface 106 defining the plurality of housing openings 200a-n, a bottom wall 108 with a planar surface coupled thereto and configured to support the housing 102 (preferably in a level configuration), and a sidewall 110 surrounding the upper wall 104 and the bottom wall 110. The walls may again be formed with a substantially rigid material that is preferably insulated to reduce heat exchange from the chamber 300 to an outside ambient environment. The sidewall 110 and upper wall 104 are preferably integrally formed together and couplable to the bottom wall 108 in a snap-fit configuration or retained together with one or more fasteners. Each of the walls may be formed as slender panels to enable sufficient space for the plurality of housing channels 202a-n disposed within the chamber 300.

In one embodiment, each of the plurality of housing channels 202a-n span into the chamber 300 and have a channel diameter ranging from 1-5inches. In preferred embodiments, the housing channels 202a-n span uniformly into the chamber 300 and in a direction from the upper wall 104 to the bottom wall 108 of the housing 102. Each of the plurality of housing channels 202a-n may be of a cylindrical shape and configured to enable the bottles 304 to be tilted or angled (approximately 60-85°) toward the front surface 120 or sidewall outer surface 122 of the sidewall 104 to enable the users to quickly and effectively remove a bottle 304 (which is particularly advantageous late at night when users are asleep or groggy and are positioned in bed).

In one embodiment, the housing 102 includes a plurality of internal bottle retaining sidewalls 206a-n spanning into the chamber 300 and each defining and enclosing one of the plurality of housing channels 202a-n and having one of the plurality of heating coils 204 directly coupled thereto in the helical configuration. Each of the plurality of internal bottle retaining sidewalls 206a-n may extend downward toward the bottom wall 108 in an upright orientation and provide the space where a bottle and/or removable bottle holder 112 is placed. Each of the plurality of housing channels 202a-n may also uniformly span a channel diameter, e.g., 4 inches, into the chamber 300. In other embodiments, the channel diameter ranges from 1-5 inches. Each of the plurality of internal bottle retaining sidewalls 206a-n and the plurality of housing channels 202a-n may be of a cylindrical shape beneficially configured to retain and enabled quick and efficient removal of the baby bottle 304.

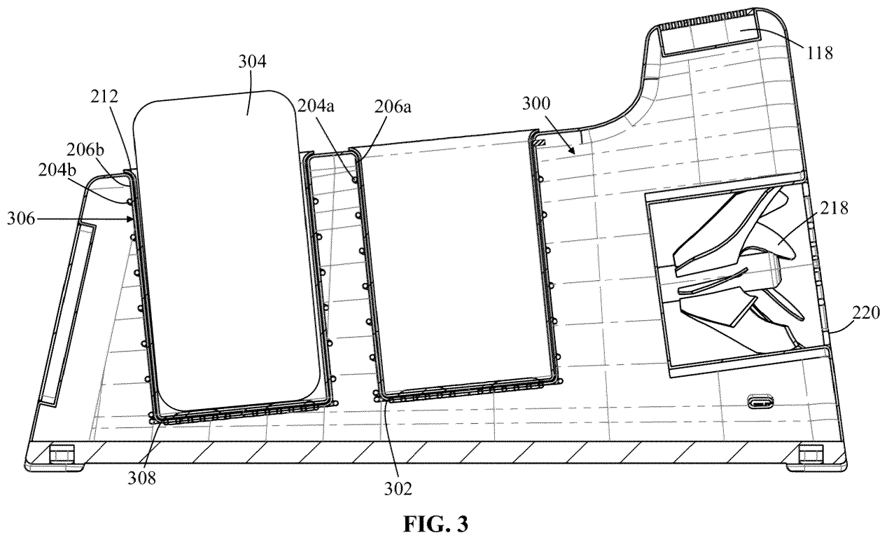

In one embodiment, a plurality of bottom retaining walls (like the wall 302 depicted best in FIG. 3) are disposed within the assembly and are preferably each coupled to one of the plurality of internal bottle retaining sidewalls 206a-n to form a bottle support structure, wherein the bottle support structure includes a sidewall and a bottom wall configured to retain and support the bottle 304 and/or a removable bottle holder 112. In preferred embodiments, the sidewall 206 and the bottom retaining wall 302 are integrally formed from one piece of the material and of a thermally conductive material, thereby allowing the respective housing channel to be cooled and warmed (when desired). Said another way, a plurality of lower heating coils 208a-n are each directly coupled to one of the plurality of bottom retaining walls 302 of a bottle support structure, also preferably in a spiral configuration, along with the heating coils 204a-n directly coupled one of the internal bottle retaining sidewalls 206a-n in said same bottle support structure, so that the respective housing channel can be warmed more effectively and efficiently. Because the assembly 100 is beneficially configured to warm just one of the plurality of housing channel 202a-n while the remainder are being cooled, in one embodiment, the mechanical refrigeration unit 602 (schematically represented in FIG. 6) is programmed to slightly decrease the temperature within the chamber 300 1-3° while the individual bottle supper structure and corresponding channel 202 is being warmed.

The mechanical refrigeration unit 602, the lower heating coils 208a-n and the heating coils 204a-n are all communicatively coupled (wirelessly or wired) to the controller 600 for selective and/or programmed control. To that end, the heating coils 204a-n and the lower heating coils 208a-n (when utilized) are operably configured to have a warming mode configured to generate an ambient temperature in a range of 100-150° F., wherein the controller 600 is operably configured to selectively cause the warming modes of both the plurality of heating coils 204a-n and the lower heating coils 208a-n in the same bottle support structure, i.e., an individual bottle support structure.

In one embodiment, each bottle support structure has an outer support surface 306 with one of the heating coils 204a-n and one of the plurality of lower heating coils 208a-n directly coupled thereto (as exemplified in FIG. 3) and also includes an inner support surface 210 opposing the outer support surface 306 and defining one of the plurality of housing channels 202a-n. Said configuration enables a lower cost manufacturing and assembly method, yet still providing an effective and efficient heating protocol for a particular housing channel 202.

In one embodiment, the plurality of removable bottle holders 112a-n are utilized and each are selectively removably coupled to one of the bottle support structures and disposed in the respective housing channel for cooling and warming. When utilizing a bottle holder 112, said bottle holder will define the respective housing channel 202 where the bottle 304 is placed. Each of the bottle holders 112a-n have a bottle holder sidewall 212 and a bottle holder bottom wall 308 to enable effective retention of a bottle 304. Preferably, each of the plurality of removable bottle holders 112a-n have a flange 214 projecting laterally from the bottle holder sidewall 212 and configured to rest on top of the upper wall surface 106 of the upper wall 104 of the housing 102. In one embodiment, said flange 214 projects from the top edge of the bottle holder sidewall 212 and may have a portion or all of the perimeter curved upwardly (relative to the bottle holder bottom wall 308) to enable the user to easily lift and remove the bottle holder 112 (e.g., for cleaning or transportation of the bottle therein). In one embodiment, each of the bottle holders 112 are connected in a unitary configuration such that all bottle holders 112a-n can be removed at the same time. This would enable the user to add multiple bottles at one time and add to the assembly 100 for cooling.

The mechanical refrigeration unit 602 utilized by the assembly is operably configured to have a cooling mode configured to generate a temperature within the chamber 300 in a range of 32-40° F., which is different than most household fridges that produce a cooling effect in a range of 4-68° F. The mechanical refrigeration unit 602 may include a refrigeration chiller, a cold separator, a glycol regeneration system, and an integrated condensate stabilizer. In other embodiments, the mechanical refrigeration unit 602 includes evaporator coils, condenser coils, a compressor, a fan (e.g., fan 218), and one or more expansion valves through which a refrigerant is retained and transported through by virtue of a conduit system. The housing 102 is preferably insulated and sealed together such that the mechanical refrigeration unit 602 produces less than 30 dB in noise. The fan 218 may be configured to dispel heat to an outside ambient environment, namely through the rear sidewall of the assembly 100.

Connecting all of the electrical components in the assembly 100 may be a controller 600, wherein the controller 600 is communicatively coupled each of the plurality of heating coils 204a-n, heating coils 208, and the mechanical refrigeration unit 602. Beneficially, the controller 600 is operably configured to selectively cause the warming mode of one of the plurality of heating coils 204a-n while the mechanical refrigeration unit 602 is in the cooling mode. The controller 600, also referred to a microcontroller, is a computer on an integrated circuit that may include one or more processing cores, a memory, and programmable input/output peripherals. Program memory in the form of NOR flash, OTP ROM, or ferroelectric RAM may be included. The controller 600 may also consist of one or more microprocessors having one or more discrete chips. The controller 600 may be programmed with code carrying out the functionality of the assembly 100 and/or may be programmed with the user through one or more inputs, e.g., through the electronic tactile display 116.

Specifically, the electronic display screen 116 may be tactile or simply to display information concerning the operation and characteristics of the assembly 100. The display screen 116 may also be communicatively coupled to the controller 600 and, being configured to be tactile, may be operably configured to receive tactile input that includes a heating time period (i.e., how long the heating coils are turned on dictated by when they are turned on and when they are turned off), the determined heating temperature for the coil(s), and the temperature within the chamber 300 generated by the mechanical refrigeration unit 602. The input may be through one or more button(s) depressible on the display or other portions of the assembly or may be through one or more electronic sensor(s).

In one embodiment, the assembly 100 utilized a thermocouple 216 disposed proximal to (i.e., at, contacting, or near, within 1″) the bottle holder sidewall 212 of one of the plurality of removable bottle holders 112a-n, namely the upper edge thereon. The thermocouple 216 may be communicatively coupled to the controller 600, wherein the controller 600 may be operably configured to selectively terminate the warming mode of the one of the plurality of heating coils 204a-n after a heating time period when the thermocouple 216 senses a determined heating temperature. Said another way, testing has shown that exposing the bottle 304 or a housing channel 202 to a determined temperature, e.g., 212° F., for a predetermined period of time, e.g., 2 mins, and factoring the conventional thermal conductivity, for example, of polypropylene 0.1-0.3 W/mK at 20° C., will warm the liquid in the bottle 304 to approximately 100-102° F.

To effectuate notice to a user of when the bottle 304 is ready, the assembly 100 may include a speaker 118. The speaker 118 may be communicatively coupled to the controller 600 and the controller 600 may be operably configured to cause the speaker 118 to emit a sound when the heating time period expires. Similarly, the controller 600 may also be operably configured to cause the electronic display 116 to emit an increased light emission when the heating time period expires. For example, the user may program a bottle to be warmed by the assembly at 12 AM, 4 AM, and 8 AM, wherein the assembly 100, namely the controller 600, may be configured to heat the bottle 304 or housing channel 202 in anticipation of the time the user desires the bottle 304 to be warmed to the desired temperature.

In one embodiment, a thermocouple 216 is disposed proximal to the bottle holder sidewall 212 of one of the plurality of removable bottle holders 112a-n and is communicatively coupled to the controller 600. The controller 600 is operably configured to selectively terminate the warming mode of the one of the plurality of heating coils 204a-n after a heating time period when the thermocouple 216 senses a determined heating temperature. When the determined temperature is reached for a particular bottle desired to be warmed, the assembly 100 may have a corresponding indicator light, e.g., light 124, that may indicate a particular color, e.g., red. When the heating time period expires, the indicator light may indicate green, for example. The assembly 100 may be programmed to blink the indicator light after the time period expires and enhance the intensity of the light if the bottle 304 is not removed from the housing channel 202. To that end, the assembly 100 may also include a proximity or detection sensor (e.g., IR sensor, weight sensor, etc.) facing the housing channel 202 or disposed within or proximal to the housing channel 202.

As such, a multi-bottle thermal modulation assembly is disclosed that can beneficially cool a plurality of bottles simultaneously and, when desired or programmed by the user, selectively warm one of the bottles while the other bottles are still being cooled, thereby preserving the contents of said bottles remaining in the assembly. Although a specific order of executing process steps has been described and depicted, the order of executing the steps may be changed relative to the order shown in certain embodiments. Also, two or more steps may be described or shown as occurring in succession, said steps may be executed concurrently or with partial concurrence in some embodiments. Certain steps may also be omitted for the sake of brevity. In some embodiments, some or all of the process steps can also be combined into a single process.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above-described features.

What is claimed is:

1. A multi-bottle thermal modulation assembly comprising:
a housing defining a chamber, defining a plurality of housing openings, and a plurality of housing channels each spanning into the chamber from one of the plurality of housing openings, and shaped and sized to receive a baby bottle;
a plurality of heating coils each surrounding one of the plurality of housing channels in a helical configuration and operably configured to have a warming mode configured to generate an ambient temperature in a range of 100-350° F.;
a mechanical refrigeration unit operably configured to have a cooling mode configured to generate a temperature within the chamber in a range of 32-40° F.; and
a controller communicatively coupled each of the plurality of heating coils and the mechanical refrigeration unit and operably configured to selectively cause the warming mode of one of the plurality of heating coils while the mechanical refrigeration unit is in the cooling mode.

2. The multi-bottle thermal modulation assembly according to claim 1, wherein each of the plurality of housing channels spanning into the chamber and is of a channel diameter ranging from 1-5 inches.

3. The multi-bottle thermal modulation assembly according to claim 1, wherein each of the plurality of housing channels uniformly spans a channel diameter into the chamber, the channel diameter ranging from 1-5 inches.

4. The multi-bottle thermal modulation assembly according to claim 1, wherein the housing further comprises:
an upper wall having an upper wall surface defining the plurality of housing openings;
a bottom wall with a planar surface coupled thereto and configured to support the housing; and
a sidewall surrounding the upper wall and the bottom wall.

5. The multi-bottle thermal modulation assembly according to claim 4, wherein the housing further comprises:
a plurality of internal bottle retaining sidewalls spanning into the chamber and each defining one of the plurality of housing channels and having one of the plurality of heating coils directly coupled thereto in the helical configuration.

6. The multi-bottle thermal modulation assembly according to claim 5, wherein each of the plurality of internal bottle retaining sidewalls and the plurality of housing channels are of a cylindrical shape configured to retain a baby bottle.

7. The multi-bottle thermal modulation assembly according to claim 5, further comprising:
a plurality of bottom retaining walls each coupled to one of the plurality of internal bottle retaining sidewalls to form a bottle support structure; and
a plurality of lower heating coils each directly coupled to one of the plurality of bottom retaining walls, communicatively coupled to the controller, and operably configured to have a warming mode configured to generate an ambient temperature in a range of 100-150° F., wherein the controller is operably configured to selectively cause the warming modes of both the one of the plurality of heating coils and one of the lower heating coils in the same bottle support structure.

8. The multi-bottle thermal modulation assembly according to claim 7, wherein each bottle support structure further comprises:
an outer support surface with one of the heating coils and one of the plurality of lower heating coils directly coupled thereto; and
an inner support surface opposing the outer support surface and defining one of the plurality of housing channels.

9. The multi-bottle thermal modulation assembly according to claim 8, further comprising:
a plurality of removable bottle holders each selectively removably coupled to one of the bottle support structures and disposed in the respective housing channel, each having a bottle holder sidewall, and each having a bottle holder bottom wall.

10. The multi-bottle thermal modulation assembly according to claim 9, wherein each of the plurality of removable bottle holders further comprises:
a flange projecting laterally from the bottle holder sidewall and configured to rest on top of the upper wall surface of the upper wall of the housing.

11. The multi-bottle thermal modulation assembly according to claim 9, further comprising:
a thermocouple disposed proximal to the bottle holder sidewall of one of the plurality of removable bottle holders and communicatively coupled to the controller, the controller operably configured to selectively terminate the warming mode of the one of the plurality of heating coils after a heating time period when the thermocouple senses a determined heating temperature.

12. The multi-bottle thermal modulation assembly according to claim 11, further comprising:
an electronic display screen communicatively coupled to the controller and operably configured to receive tactile input that includes the heating time period, the determined heating temperature, and the temperature within the chamber.

13. The multi-bottle thermal modulation assembly according to claim 11, further comprising:
a speaker communicatively coupled to the controller, the controller operably configured to cause the speaker to emit a sound when the heating time period expires.

14. The multi-bottle thermal modulation assembly according to claim 1, further comprising:
a plurality of removable bottle holders each selectively removably coupled to the housing, disposed in one of the plurality of housing channels, and each having a bottle holder sidewall and a bottle holder bottom wall.

15. The multi-bottle thermal modulation assembly according to claim 14, wherein each of the plurality of removable bottle holders further comprises:
a flange projecting laterally from the bottle holder sidewall and configured to rest on top of an upper wall surface of an upper wall of the housing.

16. The multi-bottle thermal modulation assembly according to claim 15, further comprising:
a thermocouple disposed proximal to the bottle holder sidewall of one of the plurality of removable bottle holders and communicatively coupled to the controller, the controller operably configured to selectively terminate the warming mode of the one of the plurality of heating coils after a heating time period when the thermocouple senses a determined heating temperature.
